(19) United States
(12) Patent Application Publication
(10) Pub. No.: US 2026/0121717 A1
(43) Pub. Date: Apr. 30, 2026

(54) SYSTEM AND METHOD FOR CBF SOUNDING

(71) Applicant: NXP USA, Inc., AUSTIN, TX (US)

(72) Inventors: Liwen Chu, San Ramon, CA (US); Rui Cao, Sunnyvale, CA (US); Hari Ram Balakrishnan, Chennai (IN); Hongyuan Zhang, Fremont, CA (US); Sudhir Srinivasa, Los Gatos, CA (US); Huizhao Wang, San Jose, CA (US)

(21) Appl. No.: 19/371,944

(22) Filed: Oct. 28, 2025

Related U.S. Application Data
(60) Provisional application No. 63/757,271, filed on Feb. 11, 2025.
(60) Provisional application No. 63/762,285, filed on Feb. 24, 2025.
(60) Provisional application No. 63/817,008, filed on Jun. 3, 2025.
(60) Provisional application No. 63/821,274, filed on Jun. 10, 2025.

(30) Foreign Application Priority Data
Oct. 28, 2024 (IN) 202441082051
Nov. 11, 2024 (IN) 202441086609

(51) Int. Cl. H04B 7/06; H04W 28/02

(52) U.S. Cl. CPC H04B 7/0617; H04W 28/0278

(57) ABSTRACT

Embodiments of a method and apparatus for wireless communications are disclosed. In an embodiment, a wireless device includes a wireless transceiver configured to conduct a coordinated beamforming (CBF) sounding invite and response exchange in a transmit opportunity (TXOP) for CBF sounding and a controller configured to perform a CBF sounding execution in the TXOP after the CBF sounding invite and response exchange indicates an accepted CBF sounding invite.

### CROSS-REFERENCE TO RELATED APPLICATIONS

This application is entitled to the benefit of Indian Provisional Application 20/244,1082051, filed on Oct. 28, 2024, Indian Provisional Application 20/244,1086609, filed on Nov. 11, 2024, U.S. Provisional Application 63/757,271, filed on Feb. 11, 2025, U.S. Provisional Application 63/762,285, filed on Feb. 24, 2025, U.S. Provisional Application 63/817,008, filed on Jun. 3, 2025, and U.S. Provisional Application 63/821,274, filed on Jun. 10, 2025, the contents of each of which are incorporated by reference herein in their entireties.

### BACKGROUND

Wireless communications devices, e.g., access points (APs) or non-AP devices transmit various types of information using different transmission techniques. For example, various applications, such as, Internet of Things (IOT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput.

### SUMMARY

Embodiments of a method and apparatus for wireless communications are disclosed. In an embodiment, a wireless device includes a wireless transceiver configured to conduct a coordinated beamforming (CBF) sounding invite and response exchange in a transmit opportunity (TXOP) for CBF sounding and a controller configured to perform a CBF sounding execution in the TXOP after the CBF sounding invite and response exchange indicates an accepted CBF sounding invite. Other embodiments are also disclosed.

In an embodiment, the wireless device includes a sharing wireless access point (AP), and the wireless transceiver is further configured to transmit a CBF Sounding Invite that is a buffer status report poll (BSRP) non-trigger based (NTB) trigger frame.

In an embodiment, the BSRP NTB trigger frame uses a specific type of a Feedback User information (Info) field to carry parameters for a CBF sounding negotiation.

In an embodiment, a reserved bit in a Common Info field of the BSRP NTB trigger frame is repurposed to carry an indication that the BSRP NTB trigger frame is used for the CBF sounding negotiation.

In an embodiment, a CBF Sounding Response is transmitted by a shared wireless access point (AP) and is a Multi-station (STA) Block acknowledgement (Ack) frame.

In an embodiment, the Multi-STA Block Ack frame uses a specific type of a Feedback Per Association Identifier (AID) Traffic Identifier (TID) information (Info) field to carry parameters for a CBF sounding negotiation.

In an embodiment, a reserved bit in a Block Ack Control field of the Multi-STA Block Ack frame is repurposed to carry an indication that the Multi-STA Block Ack frame is used for the CBF sounding negotiation.

In an embodiment, the CBF Sounding Invite carries information indicating a sequential CBF sounding or a joint CBF sounding, whether a shared wireless AP's CBF sounding is performed after the sharing wireless AP's CBF sounding in the TXOP.

In an embodiment, a CBF Sounding Response contains information indicating whether the shared wireless AP accepts the CBF Sounding Invite.

In an embodiment, the CBF Sounding Response contains information indicating a rejection of the CBF Sounding Invite and a rejection reason.

In an embodiment, the sharing wireless AP indicates a time duration allocated to a shared wireless AP to perform the shared wireless AP's CBF sounding after the sharing wireless AP's CBF sounding in the TXOP.

In an embodiment, a dynamic channel puncture is not allowed in a CBF sounding.

In an embodiment, the controller is further configured to perform the CBF sounding execution in the TXOP by generating a Null Data Packet Announcement (NDPA), a Null Data Packet (NDP), and a Beamforming Report Poll (BFRP) trigger frame.

In an embodiment, a method for wireless communications includes at a wireless device, conducting a coordinated beamforming (CBF) sounding invite and response exchange in a transmit opportunity (TXOP) for CBF sounding and at the wireless device, performing a CBF sounding execution in the TXOP after the CBF sounding invite and response exchange indicates an accepted CBF sounding invite.

In an embodiment, the wireless device includes a sharing wireless access point (AP), and conducting the CBF sounding invite and response exchange includes transmitting a CBF Sounding Invite that is a buffer status report poll (BSRP) non-trigger based (NTB) trigger frame.

In an embodiment, the BSRP NTB trigger frame uses a specific type of a Feedback User information (Info) field to carry parameters for a CBF sounding negotiation.

In an embodiment, a reserved bit in a Common Info field of the BSRP NTB trigger frame is repurposed to carry an indication that the BSRP NTB trigger frame is used for the CBF sounding negotiation.

In an embodiment, a CBF Sounding Response is transmitted by a shared wireless access point (AP) and is a Multi-station (STA) Block acknowledgement (Ack) frame.

In an embodiment, the Multi-STA Block Ack frame uses a specific type of a Feedback Per Association Identifier (AID) Traffic Identifier (TID) information (Info) field to carry parameters for a CBF sounding negotiation.

In an embodiment, a reserved bit in a Block Ack Control field of the Multi-STA Block Ack frame is repurposed to carry an indication that the Multi-STA Block Ack frame is used for the CBF sounding negotiation.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 illustrates some communications between a sharing AP, a shared AP, and two stations (STAs) in a two-stage Coordinated beamforming (CBF) Transmit opportunity (TXOP) in accordance with example embodiments.

FIG. 5 illustrates a CBF sounding message in accordance with example embodiments.

FIG. 6 illustrates some communications between a sharing AP, a shared AP, and two STAs in a two-stage CBF sounding TXOP in accordance with example embodiments.

FIG. 7 illustrates some communications between a sharing AP, a shared AP, and two STAs in a two-stage CBF sounding TXOP in accordance with example embodiments.

FIG. 8 illustrates some TXOP durations set by the sharing AP in the CBF TXOP depicted in FIG. 4 in accordance with example embodiments.

FIG. 9 illustrates some TXOP durations set by the sharing AP and the shared AP in the CBF TXOP depicted in FIG. 4 in accordance with example embodiments.

FIG. 10 is a process flow diagram of a method for wireless communications in accordance with example embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

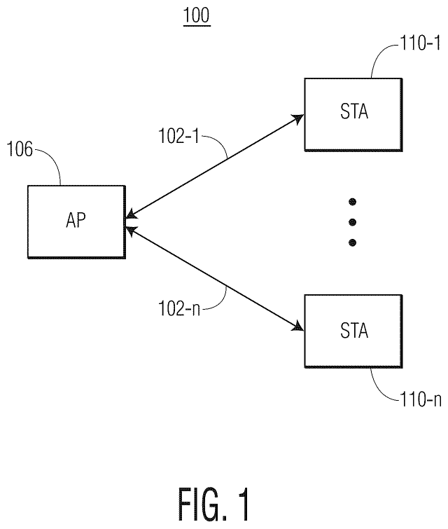

FIG. 1 depicts a wireless (e.g., WiFi) communications system 100 in accordance with an embodiment of the disclosure. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

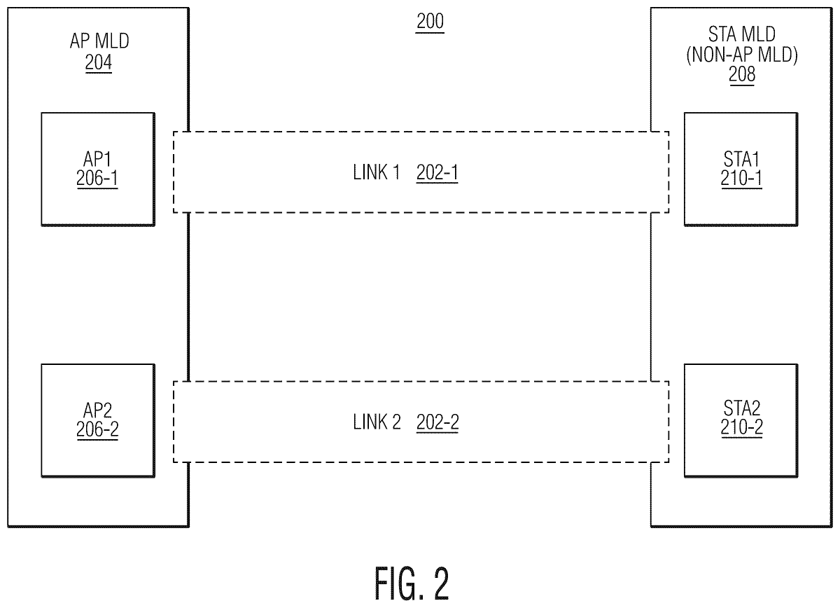

FIG. 2 depicts a multi-link (ML) communications system 200 that is used for wireless (e.g., WiFi) communications in accordance with an embodiment of the disclosure. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2. In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities that are common to multiple links (e.g., association establishment, reordering of frames, etc.) and a link specific part of the AP MLD 204, i.e., the APs 206-1 and 206-2, implement upper layer functionalities specific to a link and the lower layer MAC functionalities (e.g., Beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

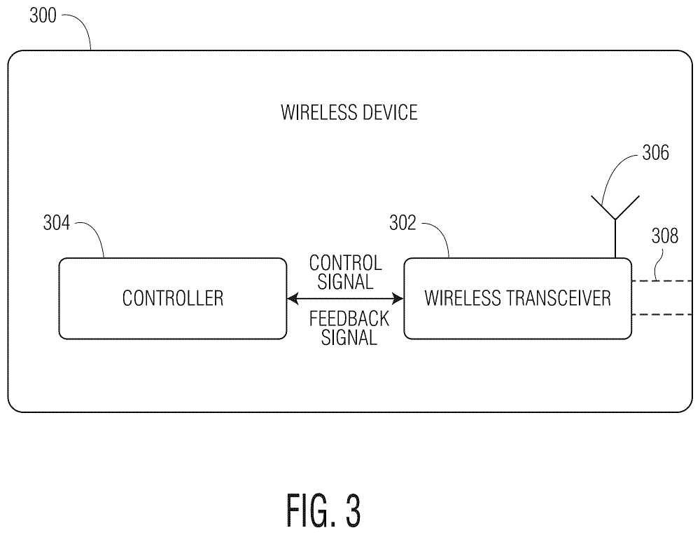

FIG. 3 depicts a wireless device 300 in accordance with an embodiment of the disclosure. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

Coordinated beamforming (CBF) is a wireless communication technique in which multiple wireless access points (APs) coordinate their beamforming efforts to reduce interference and improve performance, particularly for users at coverage edges. For example, using CBF, multiple APs can simultaneously communicate with multiple stations (STAs) wirelessly on the same frequency band. CBF may involve multiple APs beamforming together by creating constructive interference (peaks) for target STAs or users and destructive interference (nulls) in the direction of other STAs or users to minimize interference, resulting in better coverage, higher data rates, and improved system throughput. For example, an AP (e.g., a wireless AP) may act as a sharing AP that shares a transmission opportunity (TXOP) with a coordinated AP or a shared AP (e.g., a wireless AP) to perform CBF transmissions. In order to create destructive interference (nulls) toward STAs targeted by a shared AP, a sharing AP needs to perform a CBF sounding sequence towards STAs of the shared AP. Similarly, in order to create destructive interference (nulls) toward STAs targeted by a sharing AP, a shared AP also needs to perform a CBF sounding sequence towards STAs of the sharing AP.

In accordance with an embodiment of the disclosure, the wireless transceiver 302 is configured to conduct a coordinated beamforming (CBF) sounding invite and response exchange (for example, taking part in the operation or management of a CBF sounding exchange, such as to transmit and receive frames) in a transmit opportunity (TXOP) for CBF sounding, for example, through the at least one antenna 306, and the controller 304 is configured to perform a CBF sounding execution in the TXOP after the CBF sounding invite and response exchange indicates an accepted CBF sounding invite. In some embodiments, the wireless device 300 includes a sharing wireless access point (AP), wherein the wireless transceiver is further configured to transmit a CBF Sounding Invite that is a buffer status report poll (BSRP) non-trigger based (NTB) trigger frame. In some embodiments, the BSRP NTB trigger frame uses a specific type of a Feedback User information (Info) field to carry parameters for a CBF sounding negotiation. In some embodiments, a reserved bit in a Common Info field of the BSRP NTB trigger frame is repurposed to carry an indication that the BSRP NTB trigger frame is used for the CBF sounding negotiation. In some embodiments, a CBF Sounding Response is transmitted by a shared wireless access point (AP) and is a Multi-station (STA) Block acknowledgement (Ack) frame. In some embodiments, the Multi-STA Block Ack frame uses a specific type of a Feedback Per Association Identifier (AID) Traffic Identifier (TID) information (Info) field to carry parameters for a CBF sounding negotiation. In some embodiments, a reserved bit in a Block Ack Control field of the Multi-STA Block Ack frame is repurposed to carry an indication that the Multi-STA Block Ack frame is used for the CBF sounding negotiation. In some embodiments, the CBF Sounding Invite carries information indicating a sequential CBF sounding or a joint CBF sounding, whether a shared wireless AP's CBF sounding is performed after the sharing wireless AP's CBF sounding in the TXOP. In some embodiments, a CBF Sounding Response contains information indicating whether the shared wireless AP accepts the CBF Sounding Invite. In some embodiments, the CBF Sounding Response contains information indicating a rejection of the CBF Sounding Invite and a rejection reason. In some embodiments, the sharing wireless AP indicates a time duration allocated to a shared wireless AP to perform the shared wireless AP's CBF sounding after the sharing wireless AP's CBF sounding in the TXOP. In some embodiments, a dynamic channel puncture is not allowed in a CBF sounding. In some embodiments, the controller 304 is further configured to perform the CBF sounding execution in the TXOP by generating a Null Data Packet Announcement (NDPA), a Null Data Packet (NDP), and a Beamforming Report Poll (BFRP) trigger frame.

In some embodiments, the controller 304 is configured to generate a coordinated beamforming (CBF) sounding message, and the wireless transceiver 302 is configured to conduct a CBF sounding exchange (for example, taking part in the operation or management of the CBF sounding exchange, such as to transmit and receive frames) using the CBF sounding message during a CBF transmit opportunity (TXOP), for example, through the at least one antenna 306.

In some embodiments, the wireless transceiver 302 is further configured to wirelessly receive a notification from an associated device regarding whether the associated device intends be a TXOP responder of CBF transmission/sounding, for example, through the at least one antenna 306.

In some embodiments, the wireless device 300 includes a sharing wireless access point (AP) that shares the CBF TXOP, and the CBF sounding message includes a CBF sounding invite.

In some embodiments, the CBF sounding invite includes a physical layer version identification (ID), whether the CBF sounding is sequential sounding or joint sounding, whether the sharing AP performs the in-BSS sounding after the cross-BSS sounding for sequential sounding, whether the sounding initiated by a shared wireless AP is allowed in the TXOP, whether the sharing wireless AP allows the shared AP to perform the in-BSS sounding after the cross-BSS sounding for sequential sounding, and/or other parameters for the sounding.

In some embodiments, the CBF sounding invite is a buffer status report poll (BSRP) non-trigger based (NTB) trigger frame, and the BSRP NTB trigger frame contains information indicating that the BSRP NTB trigger frame is used as the CBF sounding invite.

In some embodiments, the wireless transceiver 302 is further configured to wirelessly transmit the CBF sounding invite to a shared wireless AP with which the CBF TXOP is shared.

In some embodiments, the wireless transceiver 302 is further configured to wirelessly receive a CBF sounding response from the shared wireless AP.

In some embodiments, the CBF sounding response contains information indicating that the shared wireless AP accepts the CBF sounding invite, whether the shared wireless AP accepts the sharing wireless AP's cross-BSS sounding for sequential sounding, whether the shared wireless AP accepts the shared wireless AP's cross-BSS sounding and in-BSS sounding for sequential sounding if the sharing wireless AP solicits the shared wireless AP to perform cross-BSS sounding and in-BSS sounding, and other parameters for the sounding.

In some embodiments, the CBF sounding response contains information indicating that the shared wireless AP rejects the CBF sounding invite and a rejection reason code.

In some embodiments, the CBF sounding response is a multi-station (STA) block acknowledgement (Ack) that contains information indicating that the multi-STA block Ack is used as the CBF sounding response.

In some embodiments, the controller 304 is further configured generate an initial control frame (ICF), and the wireless transceiver 302 is further configured to wirelessly transmit the ICF by the sharing/shared wireless AP to a wireless station (STA) associated with the sharing/shared wireless AP respectively.

In some embodiments, a dynamic channel puncture is not allowed in a CBF operation.

In some embodiments, the wireless device 300 is compatible with an Institute of Electrical and Electronics Engineers (IEEE) 802.11 protocol.

In some embodiments, the wireless device 300 is associated with a wireless multi-link device (MLD). In these embodiments, the wireless transceiver 302 is further configured to conduct frame exchanges (for example, taking part in the operation or management of frame exchanges, such as to transmit and receive frames) with a second wireless MLD through wireless links between the wireless MLD and the second wireless MLD.

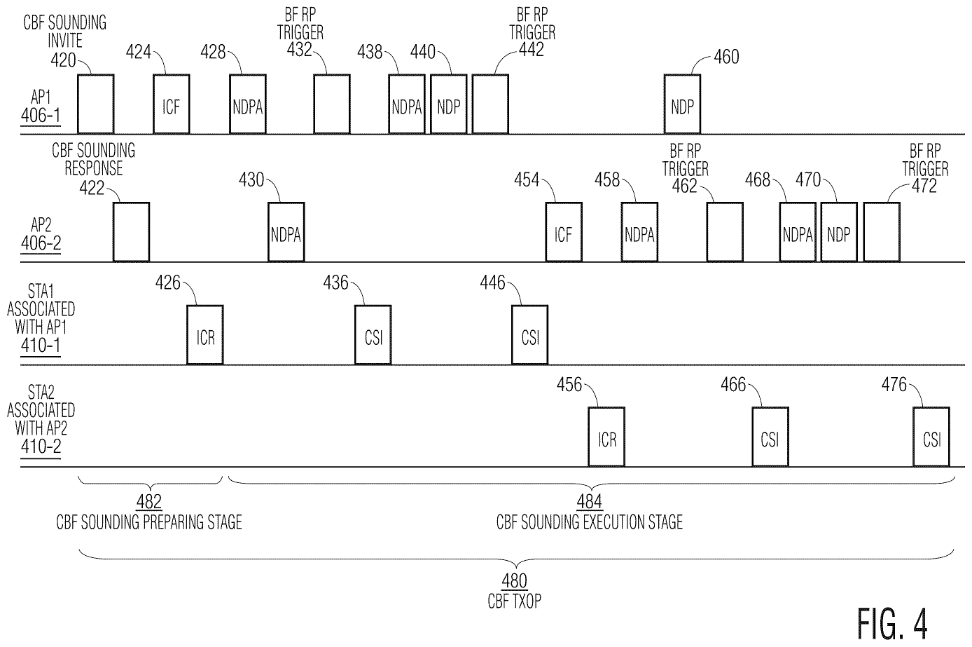

FIG. 4 illustrates some communications between a sharing AP 406-1, a shared AP 406-2, and two stations (STAs) 410-1, 410-2 in a two-stage Coordinated beamforming (CBF) Transmit opportunity (TXOP) 480 in accordance with example embodiments. In some embodiments, the sharing AP 406-1, which is also referred to as AP1, shares the CBF TXOP 480 (e.g., at least one channel (e.g., at least one wireless channel) during the CBF TXOP 480) and the shared AP 406-2, which is also referred to as AP2, is an AP with which the CBF TXOP 480 (e.g., at least one channel (e.g., at least one wireless channel) during the CBF TXOP 480) is shared. In some embodiments, the STA 410-1, which is also referred to as STA1, associates with the sharing AP 406-1 and the STA 410-2, which is also referred to as STA2, associates with the shared AP 406-2. As illustrated in FIG. 4, the two-stage CBF TXOP 480 includes a CBF sounding preparing stage 482 (also referred to as a polling stage) and a CBF sounding data frame exchange stage 484. The sharing AP 406-1 and/or the shared AP 406-2 depicted in FIG. 4 may be the same as or similar to an embodiment of the AP 106 depicted in FIG. 1, the APs 206-1, 206-2 depicted in FIG. 2, and/or the wireless device 300 depicted in FIG. 3. The STA 410-1 and/or the STA 410-2 depicted in FIG. 4 may be the same as or similar to an embodiment of the STA 110-1, . . . , or 110-n depicted in FIG. 1, the STA 210-1 or 210-32 depicted in FIG. 2, and/or the wireless device 300 depicted in FIG. 3.

As illustrated in FIG. 4, in a time sequence during the CBF sounding preparing stage 482, the sharing AP (AP1) 406-1 transmits a CBF sounding invite/invitation 420 to the shared AP (AP2) 406-2 and the shared AP (AP2) 406-2 transmits a CBF sounding response 422 to the sharing AP (AP1) 406-1. In some embodiments, the sharing AP (AP1) 406-1 transmits an ICF 424 to the STA (STA1) 410-1 and the STA (STA1) 410-1 transmits an initial control response (ICR) 426 to the sharing AP (AP1) 406-1. A CBF sounding can belong to two different CBF sounding types: sequential sounding type, and joint sounding type.

In the CBF sounding invite 420, the sharing AP (AP1) 406-1 announces that the CBF sounding is a sequential sounding, announces that it will perform its cross sounding and its in-BSS sounding, and invites the shared AP (AP2) 406-2 to perform the shared AP (AP2) 406-2's cross sounding and the shared AP (AP2) 406-2's in-BSS sounding. In the CBF sounding response 422, the shared AP (AP2) 406-2 accepts the invitation, and announces that it will perform its cross sounding and its in-BSS sounding. Additionally, the CBF Sounding Invite 420 and the CBF Sounding Response 422 negotiate the other CBF sounding parameters, for example, signal bandwidth (BW), Number of users and STA-ID, Number of Spatial Streams (Nss) combination or sounding dimension, Physical (Phy) version ID. During the negotiation, preamble, for example, Modulation Coding Scheme (MCS) used for each STA, 2x1944 Low Density Parity Check (LDPC) may need to be shared between the sharing AP (AP1) 406-1 and the shared AP (AP2) 406-2 as content used to populate the PHY; Signals, for example, LSIG (Legacy Signal) length/duration, TXOP, GI (Guard Interval)+LTF (Long Training Field), CBF PPDU format, may be announced by the sharing AP (AP1) 406-1 to the shared AP (AP2) 406-2.

Subsequently, as illustrated in FIG. 4, in a time sequence during the CBF sounding frame exchange stage 484, the sharing AP (AP1) 406-1 transmits a Null Data Packet Announcement (NDPA) 428 that solicits the NDP from the shared AP (AP2) 406-2 for the cross-BSS sounding and the shared AP (AP2) 406-2 transmits a Null Data Packet (NDP) 430. Subsequently, the sharing AP (AP1) 406-1 transmits a Beamforming Report Poll (BFRP) trigger frame 432 to the STA (STA1) 410-1 and the STA (STA1) 410-1 transmits a channel state information (CSI) frame 436 to the sharing AP (AP1) 406-1. Subsequently, because the sharing AP (AP1) 406-1 decides to perform in-BSS sounding besides the cross-BSS sounding, the sharing AP (AP1) 406-1 transmits an NDPA 438, an NDP 440, and a BFRP trigger frame 442 to the STA (STA1) 410-1 and the STA (STA1) 410-1 transmits a channel state information (CSI) frame 446 to the sharing AP (AP1) 406-1. Subsequently, the shared AP (AP2) 406-2 transmits an ICF 454 to the STA (STA2) 410-2 and the STA (STA2) 410-2 transmits an ICR 456 (e.g., embedded or carried in a TB PPDU) to the shared AP (AP2) 406-2.

Subsequently, the shared AP (AP2) 406-2 preform its sounding as agreed between the two APs through CBF Sounding Invite/Response. The shared AP (AP2) 406-2 transmits an NDPA 458 to solicit the sharing AP's NDP for cross-sounding and the sharing AP (AP1) 406-1 transmits an NDP 460. Subsequently, the shared AP (AP2) 406-2 transmits a BFRP trigger frame 462 to the STA (STA2) 410-2 and the STA (STA2) 410-2 transmits a channel state information (CSI) frame 466 to the shared AP (AP2) 406-2. Subsequently, because the shared AP (AP2) 406-2 decides (and agreed by the sharing AP (AP1) 406-1) to perform in-BSS sounding besides the cross-BSS sounding the shared AP (AP2) 406-2 transmits an NDPA 468, an NDP 470, and a BFRP trigger frame 472 to the STA (STA2) 410-2 and the STA (STA2) 410-2 transmits a channel state information (CSI) frame 476 to the shared AP (AP2) 406-2. In some embodiments, the sharing AP (AP1) 406-1 announces the time (e.g., a TXOP time duration) that the shared AP (AP2) 406-2 can use for the shared AP (AP2) to perform its sounding. In some embodiments, such announcement can be carried in a Multi-user (MU)-request to send (RTS) TXS (TXOP sharing) that solicit clear to send (CTS) right before the shared AP (AP2) 406-2's ICF transmission. In some embodiments, such announcement can be carried in a CBF Sounding Invite.

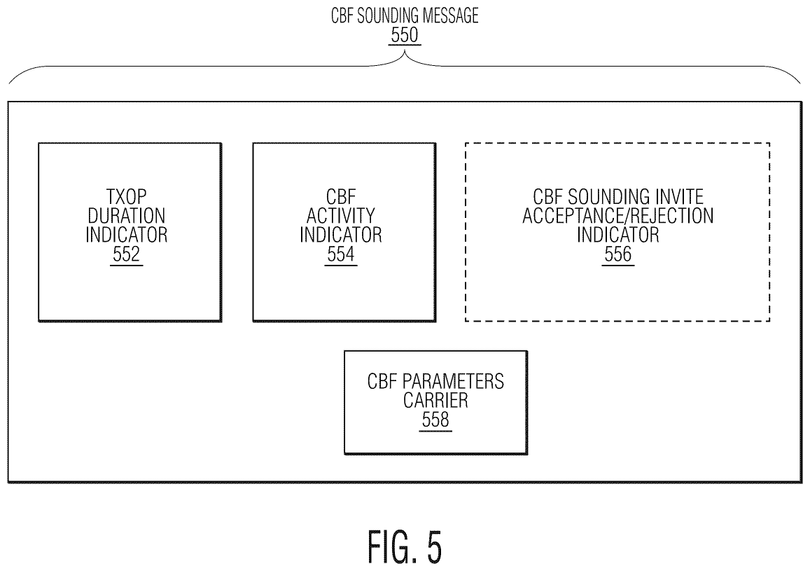

FIG. 5 illustrates a CBF sounding message 550 in accordance with an embodiment of the disclosure. The CBF sounding message 550 illustrated in FIG. 5 can be used for communications by the wireless communications system 100 depicted in FIG. 1, by a STA/AP affiliated with the multi-link (ML) communications system 200 depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4. In the embodiment depicted in FIG. 5, the CBF sounding message 550 includes a TXOP duration indicator 552, a CBF activity indicator 554, and an optional CBF Sounding Invite acceptance/rejection indicator 556. In some embodiments, the TXOP duration indicator 552 contains a TXOP duration indicator set by a wireless device that generates the CBF sounding message. In some embodiments, the CBF activity indicator 554 contains information indicating that the message is the CBF sounding message used for the CBF sounding negotiation. In some embodiments, the CBF Sounding Invite acceptance/rejection indicator 556 contains information indicating whether a wireless device that receives the CBF sounding request accepts or rejects the CBF sounding request. In some embodiments, the CBF sounding message 550 includes a CBF Parameters carrier 558, which contains information indicating the specific parameters for the CBF sounding procedure negotiation to define the CBF sounding frame exchange sequence.

In some embodiments, the CBF sounding message 550 includes a CBF sounding invite, which may be implemented as a buffer status report poll (BSRP) non-trigger based (NTB) trigger frame, and a specific frame format usage indicator contains information indicating that the BSRP NTB trigger frame is used as the CBF sounding invite.

In some embodiments, the CBF sounding message 550 includes a CBF sounding response, which includes the CBF Sounding Invite acceptance/rejection indicator 556 that contains information regarding whether ta specific wireless AP accepts or rejects a CBF sounding invite and/or information indicating a rejection reason. In some embodiments, the CBF sounding response includes a specific frame format usage indicator, which contains information indicating that a multi-STA block acknowledgement (Ack) is used as the CBF sounding response.

In some implementations, at the beginning of a TXOP for the CBF sounding, a sharing AP polls a shared AP for CBF sounding, then the shared AP sends the response to indicate whether it accepts the sounding invite. In some implementations, the sharing/shared AP indicates whether it will poll the STA(s) before transmitting an NDPA to the STA(s).

In some embodiments, a sharing AP controls the usage of the TXOP for CBF sounding, e.g., whether or not the shared AP will preforming the sounding after the sharing AP's sounding, the medium time that the share AP allocates to the shared AP's sounding.

In some embodiments, the CBF sounding invite announces its STA(s) for CBF operation in the TXOP, and the shared AP selects and announce its STA(s) for CBF sounding in a CBF sounding response.

In some embodiments, the CBF sounding invite announces the CBF group that conducts the CBF sounding, i.e., the STAs associated with the sharing AP and the STAs associated with the shared AP that join the CBF sounding.

In some embodiments, the CBF sounding invite and the CBF sounding response carry the PHY version ID.

In some embodiments, channel puncture is disallowed in CBF sounding.

In some embodiments, CBF agreement establishment is implemented.

Some implementations of STA's Enabling of CBF, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, a STA can notify its associated AP whether it would like to be the beamformee to join the CBF sounding. In some embodiments, the notification is done through an Action frame exchange (e.g., a CBF Enabling Notification Request from the STA to an AP, a CBF Enabling Notification Response from the AP to the STA).

Some implementations of CBF Sounding Prepare Stage-CBF Sounding Invite/Response, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, a buffer status report poll (BSRP) non-trigger based (NTB) Trigger frame is used as a CBF Sounding Invite. In some embodiments, the reserved bit in a Common Info field or an IEEE 802.11be's Special User Info field being repurposed to indicate that the BSRP NTB Trigger frame is used as the CBF Sounding Invite. In some embodiments, in another variant, a special User Info field(s) whose AID12 (AID stands for Association Identifier (ID)) field with a value more than 2007 indicates that the BSRP NTB is used as the CBF Sounding Invite. In some embodiments, in a third option, a new value in a Type field of a Feedback User Info field indicates that the BSRP NTB is used as the CBF Sounding Invite. Such special User Info field(s) carries the parameters for CBF sounding negotiation. In some embodiments, the CBF Sounding Invite indicates whether the CBF sounding is sequential sounding or joint sounding in the parameters for CBF sounding negotiation.

In some embodiments, a Multi-STA Block acknowledgement (Ack) is used as a CBF Sounding Response. In some embodiments, one reserved bit in a BA Control field being repurposed to indicate that the Multi-STA Block Ack is used as the CBF Sounding Response. In some embodiments, in another variant, Per Association ID (AID) Traffic Identifier (TID) Info whose AID12 field with a value more than 2007 indicates that the Multi-STA Block Ack is used as the CBF Sounding Response. In some embodiments, in a third option, a new value in a Type field of a Feedback User Info field indicates the Multi-STA Block Ack is used as the CBF Sounding Response. Such Per AID TID Info field(s) carries the parameters for CBF sounding invite negotiation.

Some implementations of CBF Sounding Prepare Stage-CBF Sequential Sounding under Single or Multiple TXOPs, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, a sharing AP that indicates the CBF sequential sounding in a CBF Sounding Invite frame further indicates in the CBF sounding invite frame explicitly 1), whether it will conduct both cross BSS sounding and in-BSS sounding 2), whether it allows a shared AP's CBF sounding (cross BSS sounding only or both cross BSS sounding and in-BSS sounding).

In some embodiments, the shared AP indicates whether it would like to accept or reject its NDPA transmission (the shared AP's CBF sounding), conduct cross BSS sounding only or conduct both cross BSS sounding and in-BSS sounding if the sharing AP allows the shared AP's both cross BSS sounding and in-BSS sounding, indicates the reject reason if the share AP rejects its NDPA transmission.

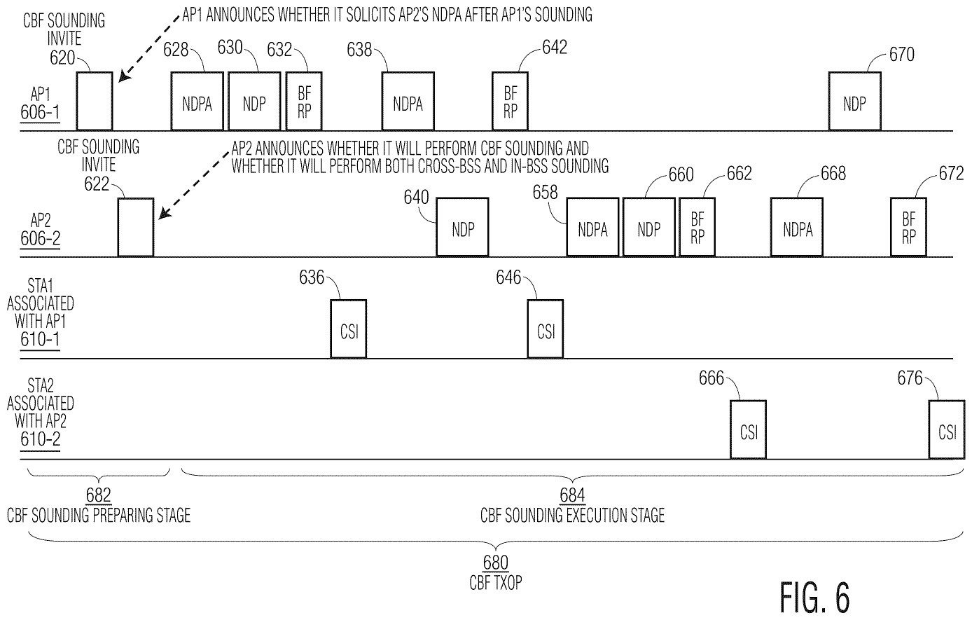

FIG. 6 illustrates some communications between a sharing AP 606-1, a shared AP 606-2, and two stations (STAs) 610-1, 610-2 in a two-stage CBF sounding TXOP 680 in accordance with example embodiments. In some embodiments, the sharing AP 606-1, which is also referred to as AP1, invites the shared AP 606-2, which is also referred to as AP2, to perform the sequential CBF sounding. In some embodiments, the STA 610-1, which is also referred to as STA1, associates with the sharing AP 606-1 and the STA 610-2, which is also referred to as STA2, associates with the shared AP 606-2. As illustrated in FIG. 6, the two-stage CBF sounding TXOP 680 includes a CBF sounding preparing stage 682 and a CBF sounding execution stage 684. The sharing AP 606-1 and/or the shared AP 606-2 depicted in FIG. 6 may be the same as or similar to an embodiment of the AP 106 depicted in FIG. 1, the APs 206-1, 206-2 depicted in FIG. 2, the wireless device 300 depicted in FIG. 3, and/or the sharing AP 406-1 and/or the shared AP 406-2 depicted in FIG. 4. The STA 410-1 and/or the STA 410-2 depicted in FIG. 4 may be the same as or similar to an embodiment of the STA 110-1, . . . , or 110-n depicted in FIG. 1, the STA 210-1 or 210-32 depicted in FIG. 2, the wireless device 300 depicted in FIG. 3, and/or the STA 410-1 and/or the STA 410-2 depicted in FIG. 4.

As illustrated in FIG. 6, in a time sequence during the CBF sounding preparing stage 682, the sharing AP (AP1) 606-1 transmits a CBF sounding invite/invitation 620 to the shared AP (AP2) 606-2 and the shared AP (AP2) 606-2 transmits a CBF sounding response 622 to the sharing AP (AP1) 606-1. In the embodiment depicted in FIG. 6, the sharing AP (AP1) 606-1 announces (e.g., in the CBF sounding invite/invitation 620 in a TXOP) that the CBF sequential sounding is executed in the TXOP, and whether it solicits the shared AP (AP2) 606-2's NDPA after the sharing AP (AP1) 606-1's sounding, and the shared AP (AP2) 606-2 announces (e.g., in the CBF sounding response 622) whether it will perform CBF sounding and whether it will perform both cross-BSS and in-BSS sounding. In some embodiments, the sharing AP (AP1) 606-1 transmits an Initial Control Frame (ICF) to the STA (STA1) 610-1 and the STA (STA1) 610-1 transmits an initial control response (ICR) (e.g., embedded or carried in a TB PPDU) to the sharing AP (AP1) 606-1.

Subsequently, as illustrated in FIG. 6, in a time sequence during the CBF sounding execution stage 684, the sharing AP (AP1) 606-1 transmits a Null Data Packet Announcement (NDPA) 628 and a Null Data Packet (NDP) 630. In some embodiments, the sharing AP (AP1) 606-1 transmits a Beamforming Report Poll (BFRP) trigger frame 632 to the STA (STA1) 610-1 and the STA (STA1) 610-1 transmits a channel state information (CSI) frame 636 to the sharing AP (AP1) 606-1. Subsequently, the sharing AP (AP1) 606-1 transmits an NDPA 638 to the shared AP (AP2) 606-2 and the shared AP (AP2) 606-2 transmits an NDP 640 to the sharing AP (AP1) 606-1. In some embodiments, the sharing AP (AP1) 606-1 transmits a BFRP trigger frame 642 to the STA (STA1) 610-1 and the STA (STA1) 610-1 transmits a CSI frame 646 to the sharing AP (AP1) 606-1. Subsequently, the shared AP (AP2) 606-2 transmits an NDPA 658 and an NDP 660. In some embodiments, the shared AP (AP2) 606-2 transmits a BFRP trigger frame 662 to the STA (STA2) 610-2 and the STA (STA2) 610-2 transmits a CSI frame 666 to the shared AP (AP2) 606-2. Subsequently, the shared AP (AP2) 606-2 transmits an NDPA 668 to the sharing AP (AP1) 606-1 and the sharing AP (AP1) 606-1 transmits an NDP 670. In some embodiments, the shared AP (AP2) 606-2 transmits a BFRP trigger frame 672 to the STA (STA2) 610-2 and the STA (STA2) 610-2 transmits a CSI frame 676 to the shared AP (AP2) 606-2.

Some implementations of CBF Sounding Prepare Stage-CBF Parallel (joint) Sounding under Single TXOP, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, a sharing AP indicates in a CBF sounding invite frame explicitly that 1) the CBF sounding in the TXOP is the joint (Parallel) sounding, and, 2) whether it allow the shared AP's NDPA transmission that follows the sharing AP's CBF sounding. In some embodiments, the shared AP indicates whether it would like to accept or reject its NDPA transmission.

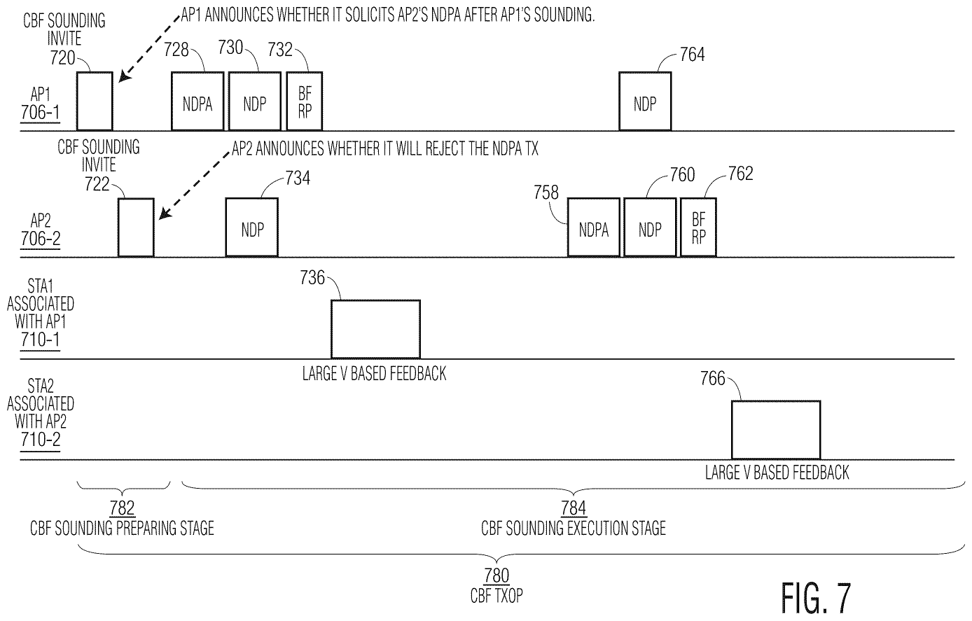

FIG. 7 illustrates some communications between a sharing AP 706-1, a shared AP 706-2, and two stations (STAs) 710-1, 710-2 in a two-stage CBF sounding TXOP 780 in accordance with example embodiments. In some embodiments, the sharing AP 706-1, which is also referred to as AP1, invites the shared AP 706-2, which is also referred to as AP2, to perform the joint CBF sounding. In some embodiments, the STA 710-1, which is also referred to as STA1, associates with the sharing AP 706-1 and the STA 710-2, which is also referred to as STA2, associates with the shared AP 706-2. As illustrated in FIG. 7, the two-stage CBF sounding TXOP 780 includes a CBF sounding preparing stage 782 and a CBF sounding execution stage 784. The sharing AP 706-1 and/or the shared AP 706-2 depicted in FIG. 7 may be the same as or similar to an embodiment of the AP 106 depicted in FIG. 1, the APs 206-1, 206-2 depicted in FIG. 2, the wireless device 300 depicted in FIG. 3, the sharing AP 406-1 and/or the shared AP 406-2 depicted in FIG. 4, and/or the sharing AP 606-1 and/or the shared AP 606-2 depicted in FIG. 6. The STA 410-1 and/or the STA 410-2 depicted in FIG. 4 may be the same as or similar to an embodiment of the STA 110-1, . . . , or 110-n depicted in FIG. 1, the STA 210-1 or 210-32 depicted in FIG. 2, the wireless device 300 depicted in FIG. 3, the STA 410-1 and/or the STA 410-2 depicted in FIG. 4, and/or the STA 610-1 and/or the STA 610-2 depicted in FIG. 6.

As illustrated in FIG. 7, in a time sequence during the CBF sounding preparing stage 782, the sharing AP (AP1) 706-1 transmits a CBF sounding invite/invitation 720 to the shared AP (AP2) 706-2 and the shared AP (AP2) 706-2 transmits a CBF sounding response 722 to the sharing AP (AP1) 766-1. In the embodiment depicted in FIG. 7, the sharing AP (AP1) 706-1 announces (e.g., in the CBF sounding invite/invitation 720) that the TXOP is used for joint CBF sounding and whether it solicits the shared AP (AP2) 706-2's NDPA after the sharing AP (AP1) 706-1's sounding and the shared AP (AP2) 706-2 announces (e.g., in the CBF sounding response 722) whether it will perform CBF sounding and whether it will reject the NDPA transmission (Tx). In some embodiments, the sharing AP (AP1) 706-1 transmits an Initial Control Frame (ICF) to the STA (STA1) 710-1 and the STA (STA1) 710-1 transmits an initial control response (ICR) (e.g., embedded or carried in a TB PPDU) to the sharing AP (AP1) 706-1.

Subsequently, as illustrated in FIG. 7, in a time sequence during the CBF sounding execution stage 784, the sharing AP (AP1) 706-1 transmits a Null Data Packet Announcement (NDPA) 728 to the shared AP (AP2) 706-2, and then the sharing AP (AP1) 706-1 transmits a Null Data Packet (NDP) 730 and the shared AP (AP2) 706-2 transmits an NDP 734 simultaneously. In some embodiments, the sharing AP (AP1) 706-1 transmits a Beamforming Report Poll (BFRP) trigger frame 732 to the STA (STA1) 710-1 and the STA (STA1) 710-1 transmits a large V-shaped feedback 736 to the sharing AP (AP1) 706-1. Subsequently, the shared AP (AP2) 706-2 transmits an NDPA 758 to the sharing AP (AP1) 706-1 and then the shared AP (AP2) 706-2 transmits a Null Data Packet (NDP) 760 and the sharing AP (AP1) 706-1 transmits an NDP 764. In some embodiments, the shared AP (AP2) 706-2 transmits a BFRP trigger frame 762 to the STA (STA2) 710-2 and the STA (STA2) 710-2 transmits a large V-shaped feedback 766 to the shared AP (AP2) 706-2.

Some implementations of CBF Sounding Prepare Stage-Handshake of PHY Version ID, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, in CBF sounding preparing handshake (CBF sounding request/response) option 1, a sharing AP (inviting AP) uses a CBF transmission request to share the Phy version in Phy version ID to a shared AP (invited AP) if the shared AP (invited AP) supports the Phy version.

In some embodiments, in CBF sounding preparing handshake (CBF sounding request/response) option 2, a sharing AP (inviting AP) uses a CBF transmission request to share the Phy version in Phy version ID to a shared AP (invited AP). In some embodiments, if/when the shared AP agrees to the Phy version, the shared AP will indicate that it will participate in the coordinated related transactions. In some embodiments, if/when the shared AP does not agree to/with the sharing AP's selection, the shared AP will indicate that it will not be participating in the coordinated related transactions.

Some implementations of CBF Sounding Prepare Stage-Handshake of Number of users and STA-ID, Nss combination, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, in CBF sounding preparing handshake (CBF sounding request/response) option 1, a sharing AP (e.g., the sharing AP (AP1) 406-1 depicted in FIG. 4) fixes, determines, or decides all the participating STAs including a shared AP's STAs (e.g., the shared AP (AP2) 406-2's the STA (STA2) 410-2 depicted in FIG. 4) and the Number of Spatial Streams (Nss) combination using an Initial Control Frame (ICF). In some embodiments, if/when the shared AP (e.g., the shared AP (AP2) 406-2 depicted in FIG. 4) agrees to the sharing AP's selection, the shared AP will indicate that it will participate in the coordinated related transactions using an initial control response (ICR). In some embodiments, if/when the shared AP does not agree with the sharing AP's selection, the shared AP will indicate that it will not be participating in the coordinated related transactions.

In some embodiments, in CBF sounding preparing handshake (CBF sounding request/response) option 2, a sharing AP (e.g., the sharing AP (AP1) 406-1 depicted in FIG. 4) fixes, determines, or decides the total number of users, and the total number of streams which will participate in the CBF transmission in an ICF. In some embodiments, the sharing AP also notifies to the shared AP the STAs (e.g., the STA (STA2) 410-2 depicted in FIG. 4) associated with the shared AP that are identified by the STA ID (AID) along with Nss used for each of those STAs, which will be scheduled by the shared AP. In some embodiments, a shared AP (e.g., the shared AP (AP2) 406-2 depicted in FIG. 4) announces the STA-ID (AID) of the participating STAs and Nss of the corresponding STAs in the CBF sounding response. In some embodiments, if the sharing AP agrees to all the parameters, the sharing AP will go forward with the coordinated related transactions, otherwise the sharing AP will not go forward with the coordinated related transactions. In some embodiments, in another variant, the sharing AP always agree with the shared AP's decision.

Some implementations of CBF Sounding Response (CBF sounding response) at CBF sounding preparing phase, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, an invited/shared AP (e.g., the shared AP (AP2) 406-2 depicted in FIG. 4 as a TXOP responder) may reject an inviting AP (e.g., the sharing AP (AP1) 406-1 depicted in FIG. 4)'s sounding invite (rejecting the invited AP's sounding) with the reason code. The reason code can be one of the following:

the invited/shared AP (e.g., the shared AP (AP2) 406-2 depicted in FIG. 4) being unavailable during the invited/shared AP's sounding (frame exchanges solicited by the invited/shared AP's NDPA), e.g., CBF sounding execution phase overlapped with the invited/shared AP's Restricted Target Wake Time (R-TWT) Service Period (SP);

the invited/shared AP (e.g., the shared AP (AP2) 406-2 depicted in FIG. 4)'s associated STA which is the destination of the invited/shared AP's beamformee being unavailable, e.g., CBF sounding phase overlapped with the unavailable time of the invited/shared AP's beamformee;

the allocated medium time for invited/shared AP (e.g., the shared AP (AP2) 406-2 depicted in FIG. 4)'s CBF sounding is not enough for the invited/shared AP (e.g., the shared AP (AP2) 406-2 depicted in FIG. 4)'s sounding (e.g., frame exchanges being solicited by the invited/shared AP NDPA);

TXOP duration is not enough for the invited/shared AP (e.g., the shared AP (AP2) 406-2 depicted in FIG. 4)'s sounding (frame exchanges being solicited by the invited/shared AP NDPA.

Some implementations of Unavailable Sounding Feedback Report, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, besides unavailable sounding feedback indication through a CBF Transmission Response frame, an AP can report its no cross-BSS CBF sounding feedback as an invited AP in the CBF sounding phase through a public Action frame.

Some implementations of Dynamic Power Save (DPS)/EMLSR (Enhanced Multi-Link Single Radio) STA Support in CBF Sounding, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, in a TXOP for CBF sounding, the ICF/ICR exchange transmitted by either an inviting AP (e.g., the sharing AP (AP1) 406-1 depicted in FIG. 4) or an invited AP (e.g., the shared AP (AP2) 406-2 depicted in FIG. 4) to solicit its associated beamformee's switch from a listening mode to a frame exchange mode for an EMLSR beamformee and switch from a low-capacity (LC) mode to a high-capacity (HC) mode for a DPS beamformee right before the AP's first NDPA frame transmission.

Some implementations of Dynamic Channel Puncture and CBF Operation, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, the dynamic channel puncture is not allowed in a CBF operation. In some embodiments, two APs exchange static channel puncture information during the CBF negotiation. In some embodiments, the maximal BW for a CBF operation is the BW (BW1) covering both APs' primary channel, and for any other BW wider than BW1, the two APs have the different punctured 20 MHz channel.

Some implementations of CBF Sounding TXOP Duration setting in a soliciting frame, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

It may be difficult for an inviting AP to estimate the medium time used by an invited AP's sounding.

In some embodiments, an invited AP (e.g., the shared AP (AP2) 406-2 depicted in FIG. 4) is allowed to finish its sounding even if the remaining time of an inviting AP (e.g., the sharing AP (AP1) 406-1 depicted in FIG. 4)'s TXOP reservation (e.g. indicated in Duration field of the inviting AP's CBF Sounding Invite, NDPA, BFRP Trigger) is less. In some embodiments, an invited AP (e.g., the shared AP (AP2) 406-2 depicted in FIG. 4) is allowed to finish its sounding even if the time allocated by an inviting AP (e.g., the sharing AP (AP1) 406-1 depicted in FIG. 4) to the invited AP (e.g., the shared AP (AP2) 406-2 depicted in FIG. 4) is less or not sufficient.

In some embodiments, an invited AP (e.g., the shared AP (AP2) 406-2 depicted in FIG. 4) reports its medium time for its sounding in a CBF Sounding Response frame. In some embodiments, the Duration field in a CBF Sounding Invite frame indicates the TXOP duration of CBF sounding. In some embodiments, the invited AP's CBF sounding needs to be finished no later than the end of the TXOP indicated by the Duration field of the CBF Sounding Invite frame.

Some implementations of Network Allocation Vector (NAV) and Virtual Carrier Sensing under CBF, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, if/when a frame carries both an inviting AP (e.g., the sharing AP (AP1) 406-1 depicted in FIG. 4)'s MAC address and an invited AP (e.g., the shared AP (AP2) 406-2 depicted in FIG. 4)'s MAC address in its MAC header and is in a non-HT (high throughput) duplicate PPDU, the Duration in the frame's MAC header or a TXOP field in the PHY header will be used to set the intra-BSS NAV timer of all the beamformees (STAs associated with the sharing/shared AP that are addressed by the NDPA, NDP) of a CBF sounding. In some embodiments, a CBF Sounding Invite and a CBF Sounding Response satisfy such requirement. In some embodiments, a CBF Sounding Invite needs to carry the TXOP duration long enough to cover at least the invited AP's ICF (if exists) or the invited AP's NDPA (if the invited AP does not transmit the ICF). In some embodiments, a CBF Sounding Invite needs to carry the TXOP duration long enough to cover at least the inviting AP's CBF sounding (frame exchanges initiated by the inviting AP's NDPA), i.e. the last frame before the invited AP's ICF (if exist) or the invited AP's NDPA (if invited AP doesn't transmit ICF). In some embodiments, the TXOP usage rules need to be updated, e.g., a TXOP responder can use the medium time more than the time announced by the Duration fields of the frame transmitted by the TXOP holder.

In some embodiments, other than the CBF Sounding Invite frame, the time duration defined by the Duration field of a frame transmitting by the sharing AP (e.g., the sharing AP (AP1) 406-1 depicted in FIG. 4) does not cover the time when (or the time Short Interframe Space (SIFS) before) the shared AP (e.g., the shared AP (AP2) 406-2 depicted in FIG. 4) transmits its frame that solicits response. In some embodiments, in a variant, the time duration defined by the Duration field of a frame transmitting by the sharing AP does not cover the time when (or the time SIFS before) the STA associated with the shared AP transmits its frame solicited by the shared AP that needs the carrier sensing before transmitting the response.

In some embodiments, other than the CBF Sounding Response frame, the time duration defined by the Duration field of a soliciting frame transmitted by the shared AP (e.g., the shared AP (AP2) 406-2 depicted in FIG. 4) cannot cover the time when (or the time SIFS before) the sharing AP (e.g., the sharing AP (AP1) 406-1 depicted in FIG. 4) transmits its frame that solicits response. In some embodiments, in a variant, the time duration defined by the Duration field of a frame transmitting by the shared AP does not cover the time when (or the time SIFS before) the sharing AP transmits its frame that solicits the STA associated with the sharing AP to transmit the response. In some embodiments, in a variant, the time duration defined by the Duration field of a frame transmitting by the shared AP does not cover the time when (or the time SIFS before) the STA associated with the sharing AP transmits its frame solicited by the sharing AP that needs the carrier sensing before transmitting the response.

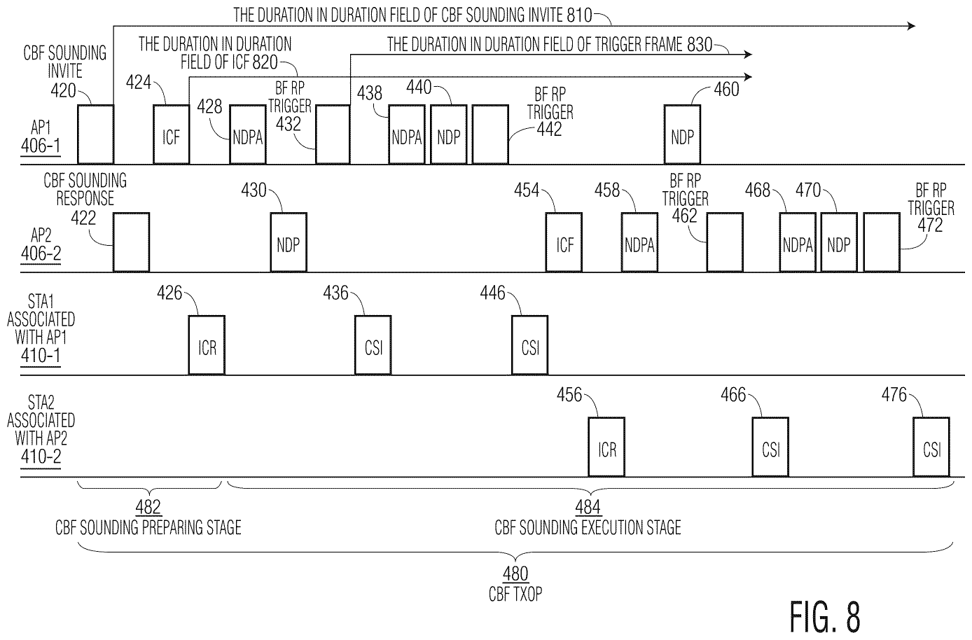

FIG. 8 illustrates some TXOP durations 810, 820, 830 set by the sharing AP 406-1 in the CBF TXOP 480 depicted in FIG. 4 in accordance with example embodiments. As illustrated in FIG. 8, the sharing AP 406-1 sets a TXOP duration 810 in a duration field of the CBF Sounding Invite 420, a TXOP duration 820 in a duration field of the ICF 424, and a TXOP duration 830 in a duration field of the BFRP trigger frame 432. The TXOP duration 810 set by the CBF Transmission Invite 420 is long enough to cover the whole TXOP for the CBF sounding, while the TXOP duration 820 set by the ICF 424 is long enough to cover the sharing AP's CBF sounding and the TXOP duration 830 set by the BFRP trigger frame 432 is long enough to cover the sharing AP's CBF sounding. The duration of a responding frame is not shown in FIG. 8 because the end time indicated by the responding frame is same as the ending time indicated by a soliciting frame.

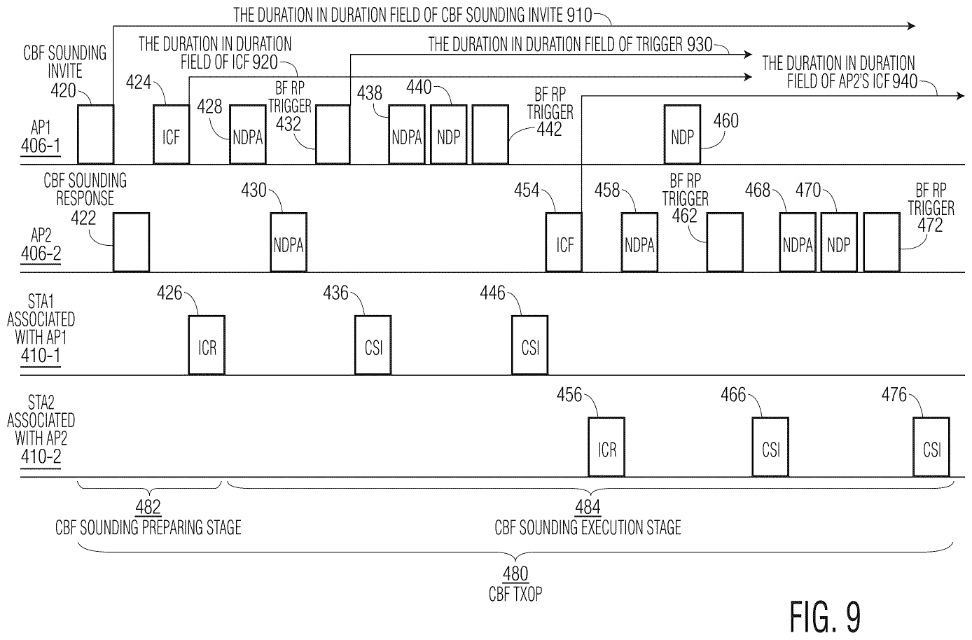

FIG. 9 illustrates some TXOP durations 910, 920, 930, 940 set by the sharing AP 406-1 and the shared AP 406-2 in the CBF TXOP 480 depicted in FIG. 4 in accordance with example embodiments. As illustrated in FIG. 9, the sharing AP 406-1 sets a TXOP duration 910 in a duration field of the CBF Transmission Invite 420, a TXOP duration 920 in a duration field of the ICF 424, and a TXOP duration 930 in a duration field of the BFRP trigger frame 432, while the sharing AP 406-2 sets a TXOP duration 940 in a duration field of the ICF 454. The TXOP duration 910 set by the CBF Transmission Invite 420 is long enough to cover part of the shared AP's CBF sounding, the TXOP duration 920 set by the ICF 424 is long enough to cover the sharing AP's CBF sounding, and the TXOP duration 930 set by the BFRP trigger frame 432 is long enough to cover the sharing AP's CBF sounding. However, the TXOP duration 910 set by the CBF Transmission Invite 420 (sent by the sharing AP (AP1) 406-1) is not long enough to cover the whole TXOP for CBF sounding. The shared AP (AP2) 406-2 extends the TXOP through one of its soliciting frame, e.g., the ICF, by using the value (940) of its Duration field to set the remaining time of the TXOP. The duration of a responding frame is not shown in FIG. 9 since the end time indicated by the responding frame is same as the ending time indicated by a soliciting frame.

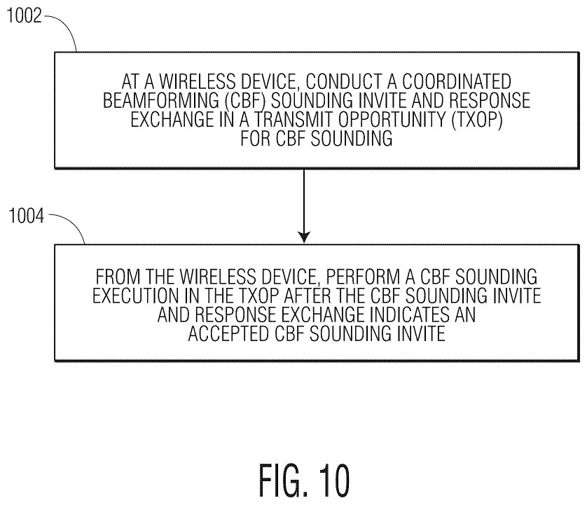

FIG. 10 is a process flow diagram of a method for wireless communications in accordance with an embodiment of the disclosure. At block 1002, at a wireless device, a coordinated beamforming (CBF) sounding invite and response exchange is conducted in a transmit opportunity (TXOP) for CBF sounding. At block 1004, at the wireless device, a CBF sounding execution is performed in the TXOP after the CBF sounding invite and response exchange indicates an accepted CBF sounding invite. In some embodiments, the wireless device includes a sharing wireless access point (AP), and a CBF Sounding Invite that is a buffer status report poll (BSRP) non-trigger based (NTB) trigger frame is transmitted. In some embodiments, the BSRP NTB trigger frame uses a specific type of a Feedback User information (Info) field to carry parameters for a CBF sounding negotiation. In some embodiments, a reserved bit in a Common Info field of the BSRP NTB trigger frame is repurposed to carry an indication that the BSRP NTB trigger frame is used for the CBF sounding negotiation. In some embodiments, a CBF Sounding Response is transmitted by a shared wireless access point (AP) and is a Multi-station (STA) Block acknowledgement (Ack) frame. In some embodiments, the Multi-STA Block Ack frame uses a specific type of a Feedback Per Association Identifier (AID) Traffic Identifier (TID) information (Info) field to carry parameters for a CBF sounding negotiation. In some embodiments, a reserved bit in a Block Ack Control field of the Multi-STA Block Ack frame is repurposed to carry an indication that the Multi-STA Block Ack frame is used for the CBF sounding negotiation. In some embodiments, the CBF Sounding Invite carries information indicating a sequential CBF sounding or a joint CBF sounding, whether a shared wireless AP's CBF sounding is performed after the sharing wireless AP's CBF sounding in the TXOP. In some embodiments, a CBF Sounding Response contains information indicating whether the shared wireless AP accepts the CBF Sounding Invite. In some embodiments, the CBF Sounding Response contains information indicating a rejection of the CBF Sounding Invite and a rejection reason. In some embodiments, the sharing wireless AP indicates a time duration allocated to a shared wireless AP to perform the shared wireless AP's CBF sounding after the sharing wireless AP's CBF sounding in the TXOP. In some embodiments, a dynamic channel puncture is not allowed in a CBF sounding. In some embodiments, at the wireless device, an initial control frame (ICF) is generated and the ICF is wirelessly transmitted to a wireless station (STA) associated with the sharing wireless AP. In some embodiments, the wireless device is compatible with an Institute of Electrical and Electronics Engineers (IEEE) 802.11 protocol. In some embodiments, the wireless device is associated with a wireless multi-link device (MLD). The wireless device may be the same as or similar to an embodiment of the AP 106 depicted in FIG. 1, the APs 206-1, 206-2 depicted in FIG. 2, the wireless device 300 depicted in FIG. 3, the sharing AP (AP1) 406-1 and/or the shared AP (AP2) 406-2 depicted in FIG. 4, the sharing AP (AP1) 606-1 and/or the shared AP (AP2) 606-2 depicted in FIG. 6, and/or the sharing AP (AP1) 706-1 and/or the shared AP (AP2) 706-2 depicted in FIG. 7.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A wireless device comprising:
a wireless transceiver configured to conduct a coordinated beamforming (CBF) sounding invite and response exchange in a transmit opportunity (TXOP) for CBF sounding; and
a controller configured to perform a CBF sounding execution in the TXOP after the CBF sounding invite and response exchange indicates an accepted CBF sounding invite.

2. The wireless device of claim 1, wherein the wireless device comprises a sharing wireless access point (AP), and wherein the wireless transceiver is further configured to transmit a CBF Sounding Invite that is a buffer status report poll (BSRP) non-trigger based (NTB) trigger frame.

3. The wireless device of claim 2, wherein the BSRP NTB trigger frame uses a specific type of a Feedback User information (Info) field to carry a plurality of parameters for a CBF sounding negotiation.

4. The wireless device of claim 3, wherein a reserved bit in a Common Info field of the BSRP NTB trigger frame is repurposed to carry an indication that the BSRP NTB trigger frame is used for the CBF sounding negotiation.

5. The wireless device of claim 1, wherein a CBF Sounding Response is transmitted by a shared wireless access point (AP) and is a Multi-station (STA) Block acknowledgement (Ack) frame.

6. The wireless device of claim 5, wherein the Multi-STA Block Ack frame uses a specific type of a Feedback Per Association Identifier (AID) Traffic Identifier (TID) information (Info) field to carry a plurality of parameters for a CBF sounding negotiation.

7. The wireless device of claim 6, wherein a reserved bit in a Block Ack Control field of the Multi-STA Block Ack frame is repurposed to carry an indication that the Multi-STA Block Ack frame is used for the CBF sounding negotiation.

8. The wireless device of claim 2, wherein the CBF Sounding Invite carries information indicating a sequential CBF sounding or a joint CBF sounding, whether a shared wireless AP's CBF sounding is performed after the sharing wireless AP's CBF sounding in the TXOP.

9. The wireless device of claim 8, wherein a CBF Sounding Response contains information indicating whether the shared wireless AP accepts the CBF Sounding Invite.

10. The wireless device of claim 8, wherein the CBF Sounding Response contains information indicating a rejection of the CBF Sounding Invite and a rejection reason.

11. The wireless device of claim 2, wherein the sharing wireless AP indicates a time duration allocated to a shared wireless AP to perform the shared wireless AP's CBF sounding after the sharing wireless AP's CBF sounding in the TXOP.

12. The wireless device of claim 1, wherein a dynamic channel puncture is not allowed in a CBF sounding.

13. The wireless device of claim 1, wherein the controller is further configured to perform the CBF sounding execution in the TXOP by generating a Null Data Packet Announcement (NDPA), a Null Data Packet (NDP), and a Beamforming Report Poll (BFRP) trigger frame.

14. A method for wireless communications, the method comprising:
at a wireless device, conducting a coordinated beamforming (CBF) sounding invite and response exchange in a transmit opportunity (TXOP) for CBF sounding; and
at the wireless device, performing a CBF sounding execution in the TXOP after the CBF sounding invite and response exchange indicates an accepted CBF sounding invite.

15. The method of claim 14, wherein the wireless device comprises a sharing wireless access point (AP), and wherein conducting the CBF sounding invite and response exchange comprises transmitting a CBF Sounding Invite that is a buffer status report poll (BSRP) non-trigger based (NTB) trigger frame.

16. The method of claim 15, wherein the BSRP NTB trigger frame uses a specific type of a Feedback User information (Info) field to carry a plurality of parameters for a CBF sounding negotiation.

17. The method of claim 16, wherein a reserved bit in a Common Info field of the BSRP NTB trigger frame is repurposed to carry an indication that the BSRP NTB trigger frame is used for the CBF sounding negotiation.

18. The method of claim 14, wherein a CBF Sounding Response is transmitted by a shared wireless access point (AP) and is a Multi-station (STA) Block acknowledgement (Ack) frame.

19. The method of claim 18, wherein the Multi-STA Block Ack frame uses a specific type of a Feedback Per Association Identifier (AID) Traffic Identifier (TID) information (Info) field to carry a plurality of parameters for a CBF sounding negotiation.

20. The method of claim 19, wherein a reserved bit in a Block Ack Control field of the Multi-STA Block Ack frame is repurposed to carry an indication that the Multi-STA Block Ack frame is used for the CBF sounding negotiation.
